(19) United States
(12) Patent Application Publication
(10) Pub. No.: US 2022/0058729 A1
(43) Pub. Date: Feb. 24, 2022

(54) FLEXIBLE VEHICLE LOAN APPLICATIONS

(71) Applicant: STATE FARM MUTUAL AUTOMOBILE INSURANCE COMPANY, Bloomington, IL (US)

(72) Inventors: Michael Dennis Albers, Morton, IL (US); Amanda Leigh Eich, Bloomington, IL (US); Alissa Jeannine Fesler, Bloomington, IL (US); Melissa Meyers Holladay, St. Peters, MO (US); Janis A. Humberd, St. Charles, MO (US); Theresa E. Lommatsch, Bloomington, IL (US); Heather Rae Lynch, Bloomington, IL (US); Stacy Lynn Miller, Normal, IL (US); Lori Mullen, Bunker Hill, IL (US); David Vela, Bloomington, IL (US); Louis C. Zayas, Normal, IL (US)

(21) Appl. No.: 16/812,650

(22) Filed: Mar. 9, 2020

Related U.S. Application Data
(63) Continuation of application No. 14/712,427, filed on May 14, 2015, now abandoned.
(60) Provisional application No. 62/045,323, filed on Sep. 3, 2014.

(51) Int. Cl. G06Q 40/02

(52) U.S. Cl. CPC G06Q 40/025

(57) ABSTRACT

Methods and/or systems for a flexible loan application process for financing a vehicle may provide multiple user interface channels (which include both multiple manual and electronic user interface channels) via which the applicant may initiate, monitor, access, and/or close the loan, as the applicant desires. Further, for a single loan application, the applicant may only need to provide limited information at the outset. Subsequently, the flexible loan application process may provide multiple approved loan offers of varying loan amounts and/or loan terms based upon the limited applicant information received. The applicant may then select one or more of the offers to customize, within approved limits, to generate a vehicle loan that best suits his or her preferences without having to restart the entire loan application process.

### CROSS REFERENCE TO RELATED APPLICATIONS

This application is a continuation of U.S. application Ser. No. 14/712,427, entitled “FLEXIBLE VEHICLE LOAN APPLICATIONS” which was filed on May 14, 2015, which claims the benefit of U.S. Provisional Application No. 62/045,323, entitled “FLEXIBLE VEHICLE LOAN APPLICATIONS” which was filed on Sep. 3, 2014. The entire disclosures of these applications are hereby incorporated by reference herein in their entireties.

### FIELD OF THE DISCLOSURE

This disclosure generally relates to flexible vehicle loan applications, and in particular, to flexibly providing multiple loan offers for a single application using multiple user interface channels.

### BACKGROUND

Generally, a loan application will include the collateral, a desired loan amount and a loan term, e.g., a number of months or other time period over which the loan is to be paid off. The completed loan application may then be sent to underwriting, and if the desired loan amount and term as indicated with the loan application is approved, the loan may usually be closed in person by the applicant and the provider of the loan (or agents thereof). If the application is not approved, the applicant may re-submit the application and indicate therewith a different loan amount and/or a different loan term in hopes of being approved. For some applicants, multiple re-submissions may be required before an appropriate loan amount and/or term is eventually approved by underwriting, if at all.

The present embodiments may address the foregoing issues, such as the elapsed, lengthy amount of time before a suitable loan is eventually approved, possible multiple application re-submissions, and/or generally, a sub-optimal loan applicant experience.

### SUMMARY

A system and/a method for a flexible loan application and approval process for financing a vehicle may provide multiple user interface channels (which may include multiple manual and/or multiple electronic user interface channels) via which a loan applicant may initiate, monitor, access, and/or close the loan, as the applicant desires, at any time during the loan application and approval process. Further, for a single loan application, the flexible loan application process may provide multiple approved loan offers of varying loan amounts and/or loan terms. The loan applicant may select one or more of the offers to customize, within approved limits, to generate a vehicle loan that best suits his or her preferences without having to restart the entire loan application process.

In one aspect, a method of providing loan application processes for purchasing vehicles may include receiving a single loan application to finance a vehicle. The method may be performed, for example, by executing a particular set of computer-executable instructions stored on one or more memory or data storage devices included in one or more computing devices, thereby particularly configuring the one or more computing devices. The one or more computing devices may also include one or more processors, one or more communication interfaces and a user interface utilized by a user, such as a loan applicant. The single loan application may include application information such as personal information corresponding to the loan applicant and vehicle information indicative of the vehicle. Further, the application information may exclude and/or omit a desired and/or target amount of the loan, and/or may exclude and/or omit a term of the loan. The method may also include providing the received application information for underwriting (e.g., by transmitting the received application information via the one or more communication interfaces), and/or receiving an indication as to whether or not the single loan application was approved or denied based upon the underwriting (e.g., via the one or more communication interfaces).

Additionally, the method may include receiving (for example, via the one or more communication interfaces) a plurality of loan offers corresponding to the single loan application, e.g., when the single loan application is approved. Each loan offer of the plurality of loan offers may have been determined based upon the underwriting, and may include respective offer information and/or parameter values, such as a respective loan amount, a loan term, an annual percentage rate (APR), and/or a periodic payment amount. The method may include causing indications of the plurality of loan offers to be presented at a user interface, and receiving an indication of a user selection of one of the plurality of loan offers. The user selection may indicate an acceptance of the selected loan offer, and/or the user selection may indicate one or more modifications to one or more presented loan offers. In some cases, the method may include updating parameter values of one or more loan offers based upon the received modification(s) and/or causing the updated loan offers to be presented at the user interface. The method may include additional, fewer, or alternate actions, including those discussed elsewhere herein.

In another aspect, a system for providing a loan application process for purchasing a vehicle may include a loan application process provider. The loan application process provider may comprise, for example, computer-executable instructions stored on one or more tangible, non-transitory memories, and the loan application process provider may be communicatively connected to a plurality of user interface channels. The plurality of user interface channels may include: (i) a local application executing on a mobile device that is accessible to a user; and/or (ii) a website and/or remote application hosted by a back-end computing device, for example. In some configurations, the plurality of user interface channels may include a call center, an office of an agent of a loan provider institution, and/or a computing device utilized by an agent of the loan provider institution.

The computer-executable instructions of the loan application process provider, when executed by one or more processors, may cause the system to (a) receive loan application information corresponding to an application for a loan to finance a vehicle. The loan application information may include personal information corresponding to a loan applicant and/or vehicle information indicative of the vehicle. Notably, the loan application information may exclude any indication of an amount of the applied-for loan and a term of the applied-for loan. Further, the computer-executable instructions, when executed by one or more processors, may cause the system to (b) cause indications of one or more loan offers to be presented at a user interface. The one or more loan offers may be determined based upon underwriting of the loan application information, and each loan offer may include respective offer information, such as a respective periodic payment amount, loan amount, annual percentage rate (APR), and/or loan term. Still further, the computer-executable instructions, when executed by one or more processors, may cause the system to (c) receive a user selection of a particular loan offer from the one or more loan offers; and/or (d) close a loan corresponding to the particular loan offer. The loan application process provider may perform at least one of (a) through (d) by using a first user interface channel of the plurality of user interface channels, and the loan application process provider may perform at least one other of (a) through (d) using a second user interface channel of the plurality of user interface channels. In some situations, a user of the system may indicate which particular user interface channel is to be used to perform each of any or all of (a) through (d).

### BRIEF DESCRIPTION OF THE DRAWINGS

The figures described below depict various aspects of the system and methods disclosed herein. It should be understood that each figure depicts an embodiment of a particular aspect of the disclosed system and methods, and that each of the figures is intended to accord with a possible embodiment thereof. Further, wherever possible, the following description refers to the reference numerals included in the following figures, in which features depicted in multiple figures are designated with consistent reference numerals.

FIG. 1 is a flow chart of an exemplary method of providing a flexible loan application process for financing a vehicle, in accordance with some embodiments;

FIG. 2 is a block diagram of an exemplary system for providing flexible vehicle loan applications, in accordance with some embodiments; and

FIGS. 3A-3J include screen shots of exemplary user interfaces which may be provided by the method of FIG. 1 and/or by the system of FIG. 2, in accordance with some embodiments.

### DETAILED DESCRIPTION

The present embodiments may relate to, inter alia, providing customers the ability to apply for a vehicle or other loan, and complete the loan closing process online. A computer-implemented process may provide an efficient flow that may analyze personal information, including financial information, and a user-entered vehicle type. Based upon the personal information and the vehicle type, multiple vehicle loan offers may be presented to a customer or potential customer via a mobile device or other computing device capable of wired or wireless communication. The multiple loan offers, including loan amount and term, may be already approved by the loan provider for a specific customer before that specific customer even views the loan offers, such as via a display screen. The customer may then choose one of the multiple (and approved) vehicle loan offers (and corresponding loan terms, conditions, rates, length, etc.) that they prefer. The customer may also customize their preferred vehicle loan offer before customer acceptance.

In this manner, the user does not have to submit extraneous information during the online loan application process. For instance, the user may not be required to pre-enter loan amount, terms, length, rate, and/or other information before receiving several loan offers. Also, when a customer customizes a loan offer that they prefer, the loan terms may be re-calculated without the user having to resubmit any information, and the customer may be presented with another set of multiple loan offers based upon the user customization.

### I. EXEMPLARY LOANS

In general, the present embodiments may allow customers to have the ability to apply for a vehicle loan via a mobile device. If the customer's application is approved, a bank or other loan provider may provide multiple vehicle loan offers. The offers may include loan amounts, terms, rates, etc. and the system (such as a remote server associated with the bank) may calculate the approximate monthly payment for each offer. The customer may then have the ability to customize the loan amount and/or term (via their mobile device) to determine the best loan option to meet their needs.

Several mobile loan types may be provided. For instance, the loan products provided may relate to, or be characterized as, refinancing; dealer purchase; personal secured; private party; lease buyout; prequalification; student, and/or other loan types.

The loans provided may be for several vehicle types. For instance, the loan products provided may relate to autos; trucks; SUVs (sport utility vehicles); vans; motorcycles; boats; motorhomes; travel trailers; camping trailers; truck campers; airplanes, and/or other types of vehicles.

The mobile functionality provided may include several features. The mobile functionality provided may be associated with a mobile device of a customer and/or allow for (1) applying for a vehicle loan; (2) receiving an underwriting decision; (3) if approved, presenting multiple loan offers to the customer, such as on the mobile device display screen; (4) selecting a loan offer from the multiple approved offers; (5) customizing one of the multiple approved loan offers; (6) selecting a loan amount, term, and/or other loan conditions; (7) selecting a loan disbursement type; (8) setting up automatic payments through Automatic Clearing House (ACH); (9) electing to pay for fees (such as an origination or title fees) upfront; (10) selecting Individual Credit Disability coverage, if eligible; and/or (11) electronically signing loan documents. The mobile functionality may also provide (12) flexibility for customers to complete entire vehicle loan process on their mobile device, or they may complete the process through a customer care center or via a bank or loan provider authorized agent; and/or (13) customer collaboration availability, such as online help, click-to-chat, and/or click-to-call functionality.

A. Multiple Offers

If an application is approved, a bank or loan provider may provide multiple vehicle loan offers. The offers may include loan amounts, terms, and/or rates, and the system (e.g., remote server configured for wireless communication) may calculate the approximate monthly payment for each offer. The customer may then have the ability to customize the loan amount and/or term (via a mobile device) to determine the best loan option to meet their needs.

B. Automatic Repricing to Ensure Customer is Receiving Lowest Rate

After initial loan approval and before the offer expiration, whenever a customer or sales associate accesses the application, the interest rates may be automatically checked to determine if the current or new interest rate is lower. The customer may receive the lower of either the current or new interest rate.

C. Individual Credit Disability Insurance (ICDI)

When the vehicle loan primary applicant meets eligibility rules, a cross-sell of ICDI may occur. The vehicle loan figures may be displayed with or without the cost of ICDI premium. If the primary applicant determines that they want ICDI coverage, they may be able to complete the ICDI application on their mobile device, and if approved, they may finance the single premium amount within their vehicle loan.

In one aspect, a computer-implemented method of approving an online loan application may be provided. The method may include (1) receiving, via a processor or remote server associated with a loan provider, customer information (such as identification, financial, and/or employment information); (2) receiving, via the processor or remote server, a customer-entered or selected vehicle type; (3) automatically determining, via the processor or remote server, whether the customer qualifies for a vehicle loan; and/or (4) if so, sending multiple loan offers that are already approved to a mobile device of the customer, such as via wireless communication from the processor or remote server. As a result, the multiple approved loan offers may be presented to the customer on a display associated with the mobile device for the customer's approval or customization. Further, the multiple approved loan offers may be displayed to the customer without requiring the customer to enter extraneous loan information, such as term and amount, but rather only limited information, such as a type of vehicle that they would like to purchase. The method may include additional, fewer, or alternate actions, including those discussed elsewhere herein.

### II. EXEMPLARY FLEXIBLE LOAN APPLICATION PROCESS

The novel systems, methods, and techniques disclosed herein generally relate to providing a flexible loan application process for financing a vehicle. According to certain aspects, the flexible loan application process may be utilized and/or may correspond to the purchase of any type of vehicle, e.g., an automobile, truck, sports utility vehicle (SUV), van, motorcycle, boat or other watercraft, motorhome, travel trailer, camping trailer, recreational vehicles (RVs), truck camper, airplane, bus, tractor, farm equipment, etc. With the systems, methods, and techniques disclosed herein, a loan applicant may be provided multiple user interface channels via which the applicant may initiate, monitor, and access the entire loan application process from initiating the application process through closing an approved loan via any one or more of said user interface channels. Further, at any point during the entire loan application process, the loan applicant may utilize any of the multiple channels as desired to initiate, monitor, access, and/or further the progress and processing of the application. Still further, with a single initial loan application, the applicant may be provided with multiple loan offers of varying loan amounts and/or loan terms, which the applicant may customize (e.g., within limits) to generate a loan that best suits his or her preferences.

Additionally, although the systems, methods, and techniques disclosed herein are described with respect to loans for financing of vehicles, any one or more of these systems, methods, and techniques may easily be applied to other types of loans, such as mortgages, student loans, equity loans, business loans, debt consolidation loans, and/or other types of loans.

### III. EXEMPLARY METHOD OF PROVIDING A FLEXIBLE LOAN APPLICATION PROCESS

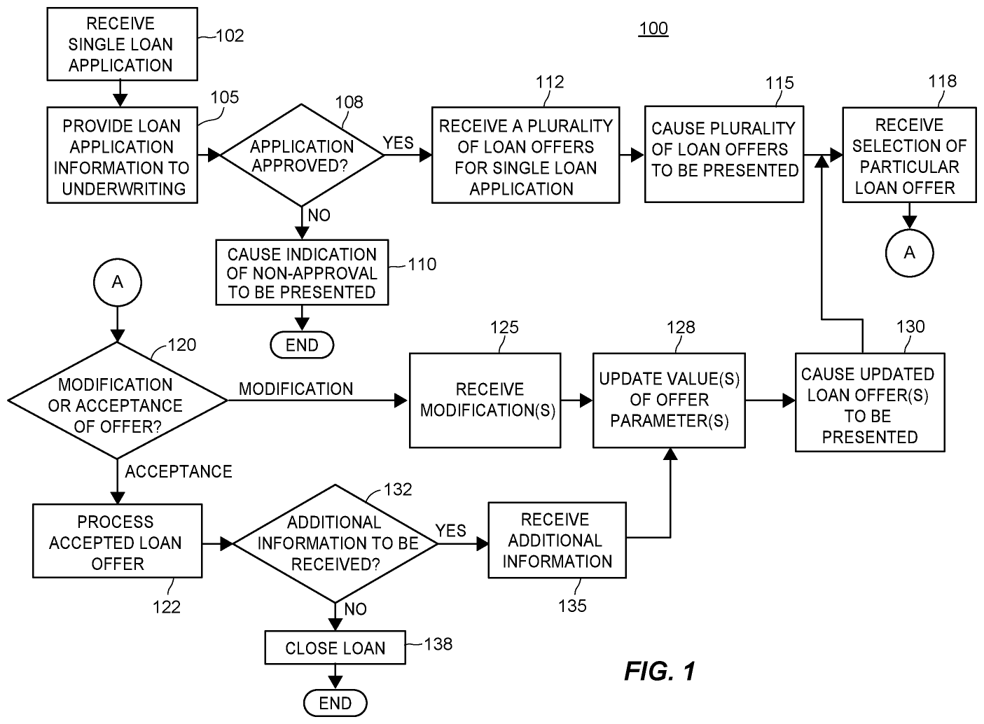

FIG. 1 illustrates a flow diagram of an exemplary method 100 for providing a flexible application process for a loan for a vehicle financing. At least a portion of the method 100 may be performed by a system that comprises one or more computing devices and, in an embodiment, the system and/or at least some of the one or more computing devices may be owned, administrated, managed by, and/or otherwise associated with an institution that may provide, offer, and/or broker vehicle loans, and that may provide the vehicle loan application process, e.g., a bank, a financial institution, an enterprise or company, a broker, a service provider, insurance provider, etc. Such institutions are generally interchangeably referred to herein as “providing institutions” or “provider institutions.” For example, the one or more computing devices may be located within a branch of a bank, or the one or more computing devices may be a website hosted by a single computing device or by a plurality of networked computing devices (e.g., a computing cloud and/or private network) of a financial services company. In an embodiment, at least a portion of the method 100 may be performed by a mobile computing device that is accessible to a loan applicant, such as a smart phone or device, tablet, or laptop used by the loan applicant. For example, the method 100 may be at least partially performed by a local application executing on the mobile computing device and/or by a browser executing on the mobile computing device, which may communicate with a website, server application, and/or remote application hosted by one or more back-end computing devices of the providing institution.

The method 100 for providing a flexible loan application process may include receiving a single loan application (block 102). The single loan application may include loan application information that is provided, for example, by a user such as a loan applicant or an agent of the loan applicant. As used herein, the terms “loan applicant” and “applicant” are used interchangeably to refer to a party under whose name the loan is being applied for. A “user,” as used herein, generally refers to the party performing the application process, which may be the loan applicant, or may be an agent of the loan applicant (e.g., a custodian, a trustee, a sales associate or agent of the providing institution, etc.).

The loan application information received at the block 102 may include applicant information, e.g., personal information corresponding to and/or indicative of the applicant. The applicant's personal information may include, for example, the applicant's name; residence or mailing address; date of birth; social security number or tax payer identification number; email address, phone number, and/or other contact information; employer name and contact information; salary or earnings amounts; amount of income from other sources (e.g., disability, alimony, etc.); type of housing (e.g., own or rent); and/or amounts of debt or other expenses (e.g., housing, alimony, other loans, etc.). Other personal information of the applicant that may be included in the loan application information may include citizenship, driver's license information, marital status, and/or other information. If more than one applicant is applying for the same loan (e.g., co-applicants, or a primary applicant and a co-signer), the loan application information may include applicant and/or personal information for each applicant.

Additionally, the loan application information may include vehicle information, e.g., information corresponding to and/or indicative of the vehicle whose financing is subject to the loan application. For example, the vehicle information may include the make, model, year, and/or body style of the vehicle. In some cases, the vehicle information may include a VIN (Vehicle Identification Number) of the vehicle.

In addition to the applicant and vehicle information, the received loan application information may further include loan information. In an embodiment, the loan information may indicate a type of loan desired by the applicant. Examples of types of loans may include a dealer purchase loan, a refinance loan, a personal secured loan, a private party loan, a lease buyout loan, a prequalification loan, student loans, and other types of loans. Based upon the type of loan indicated by the applicant, additional loan information may be included with the application. For example, if the applicant indicates that he or she desires to apply for a refinance loan, the loan information may indicate and/or identify the institution holding the existing loan, the purchase date of the vehicle with the existing loan, an outstanding balance of the existing loan, etc. In another example, if the applicant indicates that he or she desires to apply for a lease buyout loan, the loan information may indicate and/or identify the leaseholder, the start date of the lease, the lease account number, etc. Additionally or alternatively, the loan information may indicate a type of vehicle for which the loan is desired, e.g., auto, motorcycle, recreational vehicle, etc.

Notably, in the present embodiments, the loan application information may not include any indication of an amount of the loan, and the loan application information may not include any indication of a term of the loan. That is, the loan application may exclude and/or omit an indication of an amount of money that is desired to be borrowed (e.g., a loan amount). Additionally or alternatively, the loan application may exclude and/or omit an indication of a length of time over which the borrowed money is to be paid back (e.g., a loan term).

At a block 105, the method 100 may include providing or transmitting at least a portion of the received loan application information for underwriting. For example, at least some of the received loan application information may be caused to be transmitted to one or more computing devices that have access to one or more underwriting models. Such underwriting computing devices may be provided by the providing institution, and/or may be provided by another institution, e.g., by a party that provides underwriting services for the providing institution. In some embodiments, the computing devices used to perform the underwriting may be integral with the computing devices via which the loan application information is received, e.g., one or more back-end computing devices of the providing institution may integrally provide the loan application process and perform the underwriting function.

The underwriting process performed on the single loan application may utilize one or more underwriting models. Generally, said underwriting models may be configured to maximize efficiency of the loan application process, e.g., by providing multiple loan offers for a single loan application, and/or by decreasing the time for generating the multiple loan offers. For example, one or more underwriting and/or scoring models may be applied to the loan application information during underwriting.

At a block 108, the method 100 may include determining whether or not the loan application was approved, e.g., based at least partially on underwriting. For example, an indication of an approval or a denial of the loan application may be received from the one or more computing devices used to perform at least a portion of the underwriting. If the loan application was not approved, the method 100 may include causing an indication of the non-approval to be presented at a user interface (block 110), e.g., at a user interface that is accessible to the applicant and/or to the agent of the applicant. In an embodiment, an indication of one or more reasons for the non-approval, denial, and/or rejection of the loan application may be presented.

If, at the block 108, the loan application is determined to be approved, then at a block 112 the method 100 may include receiving a plurality of loan offers corresponding to the single loan application received at the block 102. For example, a plurality of loan offers may be received from the one or more computing devices used to perform at least a portion of the underwriting. Each loan offer may be an approved loan offer, and may include respective offer information that was generated based upon the underwriting of the loan application information. For example, each loan offer may include respective values for various offer parameters such as a loan amount, a loan term, an annual percentage rate (APR), and/or a periodic payment amount (e.g., a monthly payment amount) for the principal and interest of the loan offer. In some embodiments of the block 112, other loan offer information may be received. For example, approved ranges, upper limits, and/or lower limits of the values of at least some of the offer parameters may be received in conjunction with the plurality of loan offers, and said other loan offer information may have been determined and/or provided based upon the plurality of loan offers. For instance, a range of approved loan amounts, a maximum approved loan amount, and/or a range of approved loan terms corresponding to the single loan application information may be received in conjunction with the plurality of loan offers, and/or may be determined and/or provided based upon the received plurality of loan offers. Similar to the plurality of loan offers, the other loan offer information corresponding to the plurality of loan offers may be based upon (e.g., may have been determined based upon) the underwriting of the loan application information (block 105).

At a block 115, the method 100 may include causing the plurality of loan offers to be presented at a user interface, e.g., at a user interface that is accessible to the applicant and/or to the agent of the applicant. In some cases, the other received loan information (e.g., one or more of the ranges, upper limits, and/or lower limits of one or more offer parameters) may be presented in conjunction with the plurality of loan offers.

At a block 118, a selection of a particular loan offer may be received. The selection may be received via a user input, for example. When the selection indicates a user's acceptance of the particular loan offer, e.g., as determined at the block 120, the method 100 may proceed to processing the accepted loan offer (block 122).

In some cases, rather than indicating a user acceptance, the user selection as determined at the block 120 may indicate a user's modification to a particular loan offer and, at a block 125, the user's modification may be received. For example, a user may select the particular loan offer (block 118) to change a value of a particular offer parameter (e.g., the loan amount, loan term, monthly payment amount, etc.) included therein to a desired value, and the desired value of the particular offer parameter may be received as the modification (block 125). The desired value may be within an approved range and/or limit of values of the particular offer parameter, e.g., the range and/or limits presented at the block 115 in conjunction with the plurality of loan offers. In some embodiments, user modifications to multiple offer parameters of the particular loan offer may be received (block 125). In some embodiments, user modifications to multiple loan offers may be received (block 125).

Upon receiving a modification to a value of a particular offer parameter of a particular loan offer (block 125), the method 100 may automatically update the respective values of one or more other offer parameters of the particular loan offer based upon the modified parameter value (block 128). For example, if the user lengthens the loan term of the particular loan offer, the monthly payment amount may automatically be decreased accordingly, or if the user increases the amount of the loan, the monthly payment amount may automatically be increased accordingly. The particular loan offer may be updated based upon the received user modification(s) and/or other resulting offer parameter updates, and the updated particular loan offer may be caused to be presented for the user's consideration (block 130). The method 100 may then return to the block 118 to receive a user selection of the updated loan offer or of another loan offer.

Turning again to the block 120, when the user indicates the acceptance of a particular loan offer, the method 100 may include processing the accepted loan offer (block 122). In an embodiment, the method 100 may include determining if additional loan information is required, needed, and/or is to be received (block 132). In an example scenario, when the desired type of loan (e.g., as indicated at the block 102) requires or otherwise would result in a payout to a holder of an existing loan and/or lease, a verification and/or provision of existing loan and/or existing lease information from the existing loan and/or lease holder may be needed. For example, a verification and/or provision of an outstanding balance of an existing loan by the holder of the existing loan may be needed, and/or a verification and/or provision of a monthly payment amount and/or a number of months remaining on an existing loan by the holder of the existing lease may be needed. Thus, the additional loan information may include verifications and/or information from other institutions as well as copies of supporting documentation such as photo identifications, paystubs, vehicle registrations, proof of insurance, etc. In an embodiment, the method 100 may include querying another computing device for the additional loan information (not shown).

At the block 135, the additional loan information may be received, and at the block 128, values of one or more offer parameters of the accepted loan offer may be updated based upon the received, additional loan information. In some embodiments, one or more other loan offers that were previously presented (e.g., at the block 115) may also be updated based upon the received, additional loan information. The updated loan offer(s) may be caused to be presented for the user's re-consideration (block 130), and the method 100 may then return to the block 118 to receive a user selection of one of the updated loan offers.

At the block 132, if no further additional loan information is to be received, the method 100 may proceed to closing a loan corresponding to the accepted loan offer (block 138). For example, closing the accepted loan offer may include obtaining and/or receiving signatures of the applicant or applicants and/or of an agent of the providing institution. In some scenarios, at least some of the signatures may be electronically obtained or received, and/or at least some of the signatures may be electronic signatures. In some cases, closing the accepted loan offer may include obtaining an amount of funds, e.g., obtaining a down payment from an account of the applicant, obtaining cash back from a vehicle dealer, etc. For example, an electronic funds transfer (EFT) may be obtained and/or received as a part of closing the loan (block 138). In some cases, closing the accepted loan offer may include disbursing an amount of funds, e.g., to the party from which the vehicle is being financed, to an existing loan holder, to an existing lease holder, to an insurance company, etc. For example, an EFT corresponding to a disbursement of an amount of funds may be initiated as a part of closing the loan (block 138).

In some scenarios, after the applicant has approved and/or accepted a loan offer (blocks 120, 122), and/or during or after the closing of a corresponding loan (block 138), additional products of the providing institution may be offered to the applicant (not shown). For example, the method 100 may include determining one or more additional products to offer to the applicant. The determination of the one or more additional products may be made based at least partially on the received loan application information (block 102) and/or based upon the accepted loan offer (blocks 120, 122), which may or may not include user modifications.

For example, based upon the loan application information provided by the applicant and based upon the offer parameters of the closed loan, the providing institution may determine and provide an offer for an individual credit disability insurance policy for the loan, e.g., via one or more of the user interface channels of the system 200 that will be described in more detail in a later section. The individual credit disability insurance offer may be customized for the applicant, e.g., based upon the provided loan application information.

The methods, systems, and techniques for providing a flexible loan application process described herein not only may allow for multiple, flexible offers to be generated for a single loan application, as described above, but also may provide multiple, flexible user interface channels via which the loan application process may be accessed by an applicant throughout the loan application process, e.g., from initially applying for a loan to closing an approved loan. These multiple user interface channels may include, for example, one or more physical bricks-and-mortar offices of the providing institution, e.g., storefronts and/or offices of agents of the providing institution. Additionally or alternatively, these multiple user interface channels may include one or more mobile offices of the providing institution, such as a mobile computing device of an agent visiting an applicant's home or office. Further, these multiple user interface channels may additionally or alternatively include a call center via which applicants may access via telephone (e.g., a 24/7 call center); a website, portal, private network, and/or other on-line access for applicants; and/or a software and/or client application which may be downloaded to execute on an applicant's computing device and communicate with a back-end application, website and/or portal. The applicant may utilize any of the multiple user interface channels and/or any number of the multiple user interface channels, as the applicant desires, at any point of time during the loan application process.

For example, an applicant may provide loan application information (e.g., as related to the block 102 of FIG. 1) verbally or in written form at an agent's office, at a computing device located at an agent's office, via a software and/or client application executing on the applicant's mobile device, by calling into a call center, and/or by accessing a website of the providing institution. In some cases, an applicant may provide different portions of the loan application information (block 102) via different user interface channels. Similarly, an applicant may select, customize and/or modify provided loan offers (e.g., as related to the blocks 118, 125 of FIG. 1) using any of the multiple user interface channels and/or any number of the multiple user interface channels, and an applicant may close an approved loan (e.g., as related to the block 138 of FIG. 1) via any of the multiple user interface channels and/or any number of the multiple user interface channels. Indeed, different user interface channels may be used as and when desired by the applicant during the loan application process to monitor, submit, access, and/or otherwise move the loan application process forward, as is explained in more detail below.

### IV. EXEMPLARY SYSTEM FOR PROVIDING FLEXIBLE LOAN APPLICATIONS

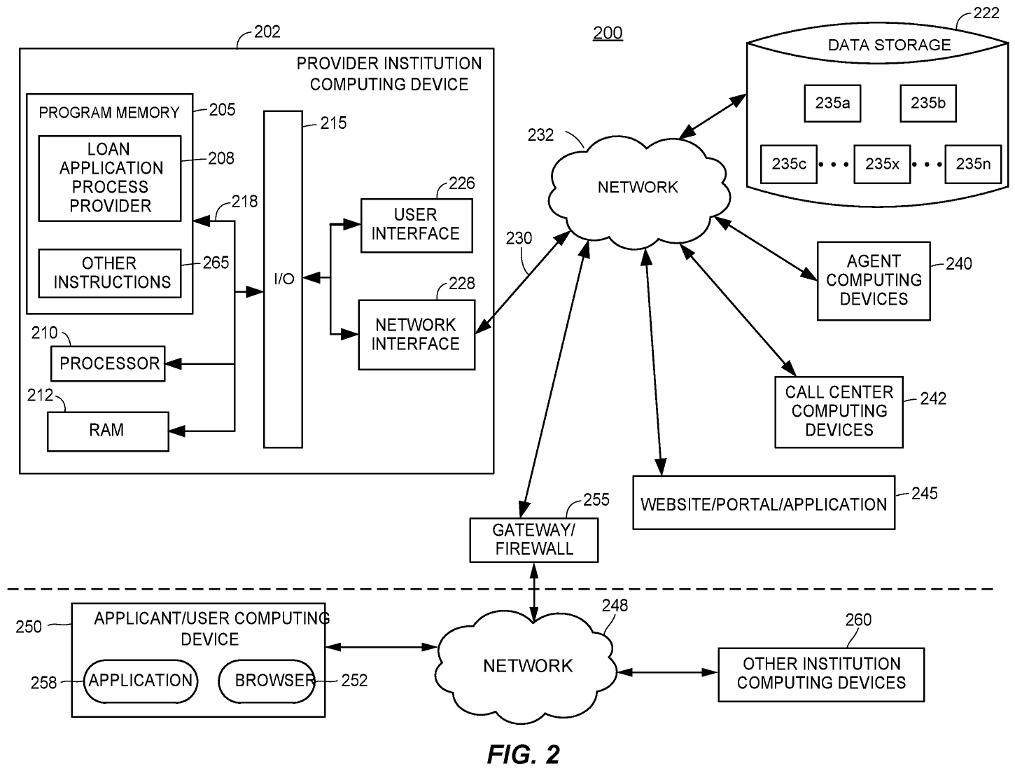

FIG. 2 includes a block diagram illustrating a present embodiment of a system 200 for providing flexible loan applications (e.g., for purchasing vehicles), and in particular, of a system 200 that may provide multiple user interface channels for supporting flexible loan application processes. The system 200 may perform at least a portion of the method 100 of FIG. 1, in an embodiment. The system may perform at least a portion of a method for flexibly providing loan applications other than the method 100, in an embodiment.

The system 200 may include one or more computing devices 202 which may be owned, operated, managed, and/or otherwise associated with an institution that provides a loan application process, e.g., a provider institution. The one or more computing devices 202 may include, for example, a computer, a server, a plurality of networked computing devices having a logical appearance of a single computing device, a plurality of cloud computing devices, etc. Accordingly, for ease of discussion only and not for limitation purposes, the computing device 202 is referred to herein using the singular tense, although in some embodiments the computing device 202 may include more than one physical computing device.

The computing device 202 may include a program memory 205, a processor 210 (may be called a controller, a microcontroller, and/or a microprocessor), a random-access memory (RAM) 212, and an input/output (I/O) circuit 215, all of which may be interconnected via an address/data bus 218. The program memory 205 may comprise one or more tangible, non-transitory computer-readable storage media and/or devices, and may store thereon a particular set of computer-readable and/or computer-executable instructions 208 that, when executed by the processor 210, cause the computing device 202 to provide a flexible loan application process. As such, the computer-readable and/or computer-executable instructions 208 are referred to interchangeably herein as a “loan application process provider 208” or a “flexible loan application process provider 208.” In an embodiment, the instructions 208, when executed, may cause the computing device 202 to implement at least a portion of the method 100.

The computing device 202 may be configured and/or adapted to access one or more data or memory storage devices 222. For example, the loan application process provider 208 may access the one or more data storage devices 222 to read and/or write data corresponding to the flexible loan application process. The one or more data storage devices 222 may comprise, for example, one or more memory devices, a data bank, cloud data storage, and/or one or more other suitable data storage devices. Indeed, the one or more data storage devices 222 may include one physical device, or the one or more data or memory storage devices 222 may include more than one physical device. The one or more data storage devices 222, though, may logically appear as a single data storage device irrespective of the number of physical devices included therein. Accordingly, for ease of discussion only and not for limitation purposes, the data storage device 222 is referred to herein using the singular tense.

The data or memory storage device 222 may be configured and/or adapted to store data related to the system 200. For example, the data storage device 222 may be configured and/or adapted to store information corresponding to an account 235a of an applicant for a loan, e.g., for a loan corresponding the purchase of a vehicle. For example, the account 235a may store received personal information, vehicle information, loan information, loan application status information, and/or other information corresponding to a loan application process initiated by the applicant. The data storage device 222 may be configured to store respective information corresponding to a plurality of accounts 235a-235n, each of which may correspond to a different loan application.

In an embodiment (not shown), at least one of the one or more data storage devices 222 may be included in the computing device 202, and the processor 210 of the computing device 202 (or the instructions 208 executed by the processor 210) may access the one or more data storage devices 222 via a link comprising a read or write command, function, application programming interface, plug-in, operation, instruction, and/or similar.

In the present embodiment illustrated in FIG. 2, though, the computing device 202 is shown as being configured to access the one or more data storage devices 222 via one or more network or communication interfaces 228 that are respectively coupled to a link 230 in communicative connection with the one or more data storage devices 222. The link 230 in FIG. 2 is depicted as a link to one or more private and/or public networks 232 (e.g., the one or more data storage devices 222 may be remotely located from the computing device 202), however, the network 232 is not required for the computing device 202 and the data storage device 222 to be communicatively connected. For example, the link 230 may provide a direct connection between the computing device 202 and the data storage device 222. The link 230 may include one or more wired links and/or one or more wireless links, and/or may utilize any suitable communications technology. The network 232 may include one or more proprietary networks, the public Internet, one or more virtual private networks, and/or some other type of network, such as dedicated access lines, plain ordinary telephone lines, satellite links, data networks, combinations of these, etc.

In an example, the network 232 may include a private network of the providing institution. As such, in this example, the network 232 may communicatively and/or securely connect other devices corresponding to the providing institution in addition to the computing device 202 and the data storage device 222. For example, the private network 232 may communicatively connect one or more agent computing devices 240 (e.g., stationary computing devices at store front and/or agent office locations and/or mobile computing devices operated by agents) and/or one or more call center computing devices 242 (e.g., stationary and/or mobile computing devices operated by call center agents of the providing institution). In an embodiment, the private network 232 may communicatively connect one or more computing devices that host one or more websites, portals, server applications, and/or remote applications of the providing institution (reference 245). For example, the website/portal computing device 245 may host a website and/or portal that is limited to access by secured devices and/or authorized users of the providing institution only (e.g., devices 202, 240, 242) for the purposes of conducting internal enterprise functions. Additionally or alternatively, the website/portal computing device 245 may host an external website, portal, server application, and/or remote application for access by loan applicants. The external website and/or remote application 245 may be accessed by applicants' computing devices 250, for example, via a browser 252 and/or a local or client application 258 executing on the applicant's device 250, and/or optionally via one or more external private and/or public networks 248 such as the Internet, other public data communications network, and/or other telecommunications network. In some configurations, a secured gateway and/or firewall 255 may be disposed between any or all of the providing institutions' devices (e.g., the network 232, devices 202, 222, 240, 242, 245) and a public gateway and/or access point, e.g., the public network 248.

Thus, as depicted in FIG. 2, any of the devices 202, 222, 232, 240, 245 and 255 may be communicatively connected to the loan application process provider 208. Also as depicted in FIG. 2, an applicant's computing device 250 may be communicatively connected to the loan application process provider 208. For example, the applicant's computing device 250 may be communicatively connected with the loan application process provider 208 via a browser 252 executing on the applicant's computing device 250 and the website and/or portal 245 of the providing institution.

In some embodiments, an applicant's computing device 250 may communicatively connect to the loan process provider 208 using an application 258 (e.g., a local software and/or client application) stored and/or executing thereon. For example, an applicant may download a client application 258 from a device of the providing institution, e.g., from the computing device 202, the host device of the external website and/or application 245, and/or the data storage device 222. Subsequently, the client application 258 and the loan application process provider 208 may establish a secure connection (e.g., a secure session) for communications therebetween over one or more public networks 248 and/or over the private network 232. Alternatively, the client application 258 and the back-end application 245 may establish a secure connection (e.g., a secure session), and the back-end application 245 may pass information between the client application 258 and the loan application process provider 208. As such, the system 200 and/or any of the devices and/or networks included therein (e.g., the devices 202, 222, 232, 240, 242, 245, 255) may be back-end devices with respect to an applicant's computing device 250.

Thus, as shown in FIG. 2, the system 200 may provide multiple user interface channels via which an applicant may utilize to flexibly apply for a loan, e.g., by interfacing with the loan application process provider 208. For example, an applicant may use his or her own computing device 205, via a browser 252 connection to a website and/or portal 245 and/or via a local client application 258. An applicant may interface with the loan application process provider 208 via an agent of the providing institution and a corresponding computing device of the providing institution 240, e.g., at the agent's office or at a remote location. An applicant may provide physical papers (e.g., loan application, supporting documentation, signatures, etc.) to an agent of the providing institution, and the agent may electronically provide the content of the physical papers to the loan application process provider 208, e.g., via the computing device 240. An applicant may interface with the loan application process provider 208 by calling into a call center 242, and a call center employee may assist the applicant by using a corresponding computing device of the providing institution 242.

In an exemplary use scenario, an applicant may initiate a loan via his or her smartphone while on site at the vehicle dealer, may later provide his or her supporting documentation from the applicant's personal computer, and, if the loan is scheduled to close while the applicant is out of town on vacation, the applicant may choose to close the loan via his or her smartphone, or alternatively, the applicant may close the loan in person at an agent's office located in the town where the applicant is vacationing. Generally, an applicant may initiate and save his or her loan application 235x using a first user interface channel of the system 200. The applicant may modify the loan application 235x using second user interface channel, and may subsequently submit the loan application 235x for underwriting (block 105) via still a third user interface channel. Further, the applicant may monitor the progress of the loan application process and/or may close the loan (block 138) using any of the user interface channels provided by the system 200.

Moreover, as can be seen from the above the discussion, the system 200 drastically shortens the time required from initial loan application submission to loan approval, at least in part by providing multiple loan offers for a single application, as well as by providing multiple channels via which a user or loan applicant may interface with the system 200 throughout the loan application process. As such, the resource usage or consumption of the system 200 during the loan approval process for the loan applicant is greatly reduced. For example, the number of processor cycles utilized by the provider institution computing device 202, the agent computing devices 240 and/or the call center computing devices 242 from initial loan application submission to loan approval may be greatly reduced by the system 200. Further, the total number of messages or traffic sent over the provider institution network 232 during the loan approval process is also greatly reduced, thereby increasing efficiencies of the network 232. Still further, as multiple loan offers are provided for a single loan application, the amount of data storage required (e.g., at the data storage device 222) to service the loan applicant is also greatly reduced.

### V. EXEMPLARY USER INTERFACE SCREENS

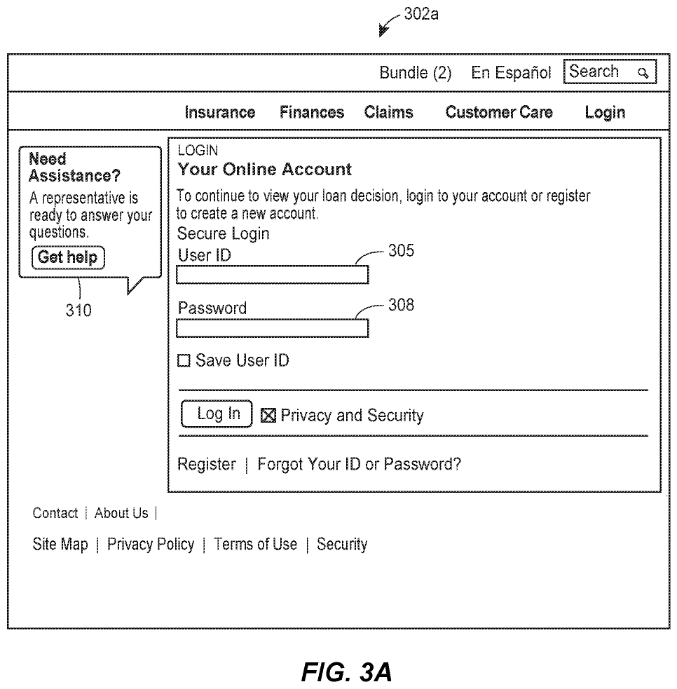

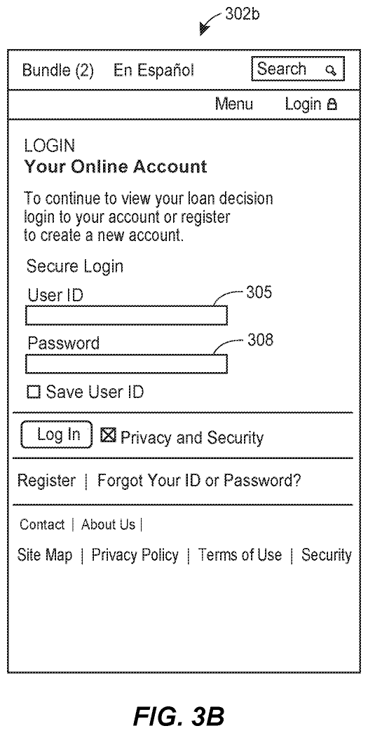

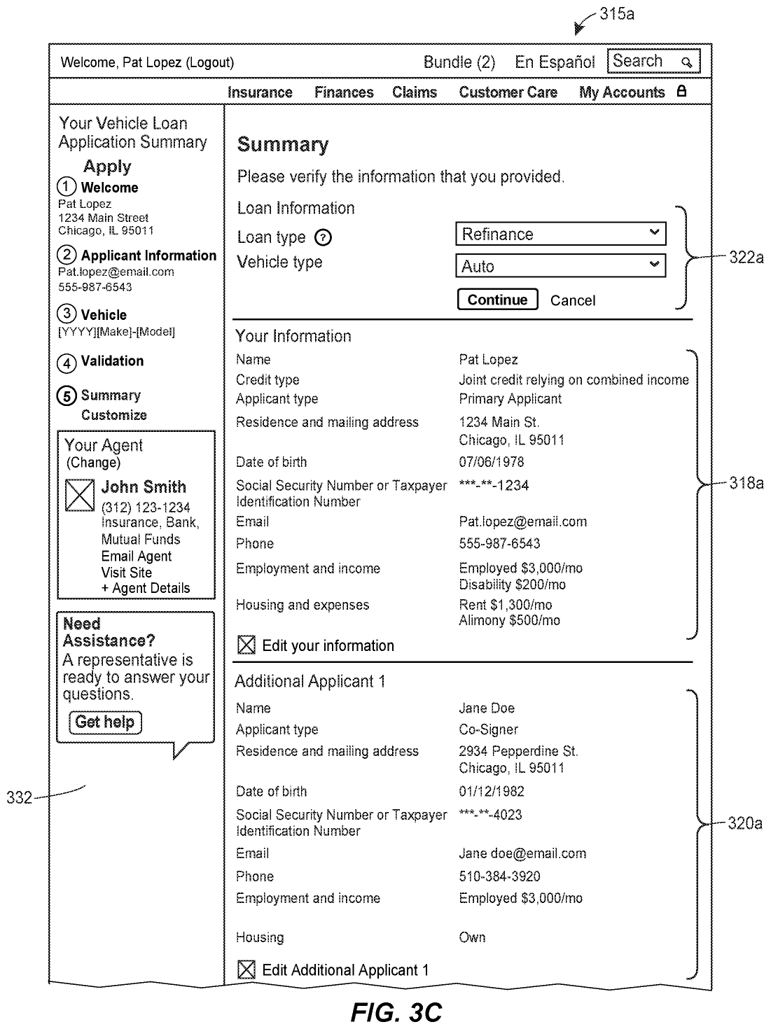

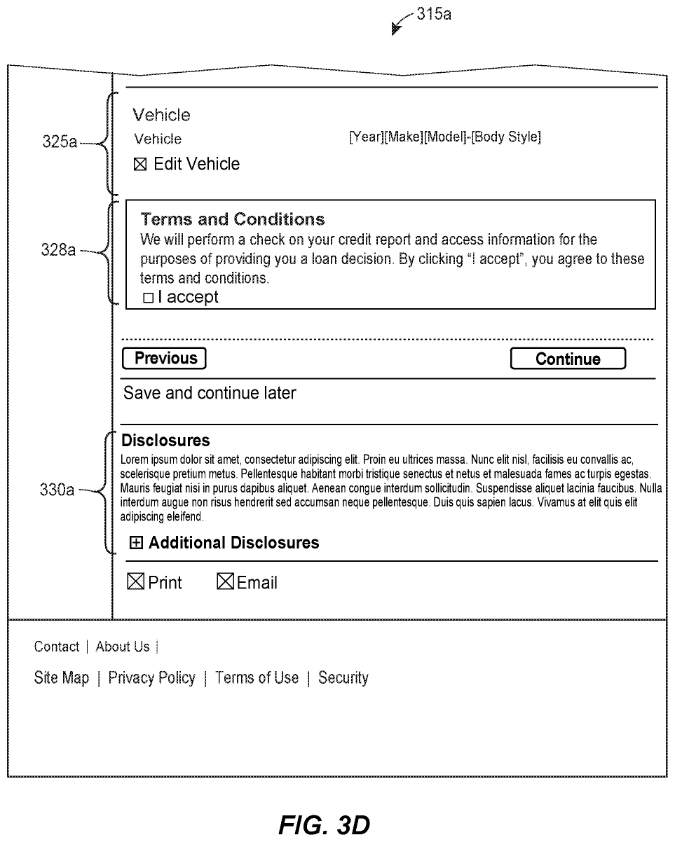

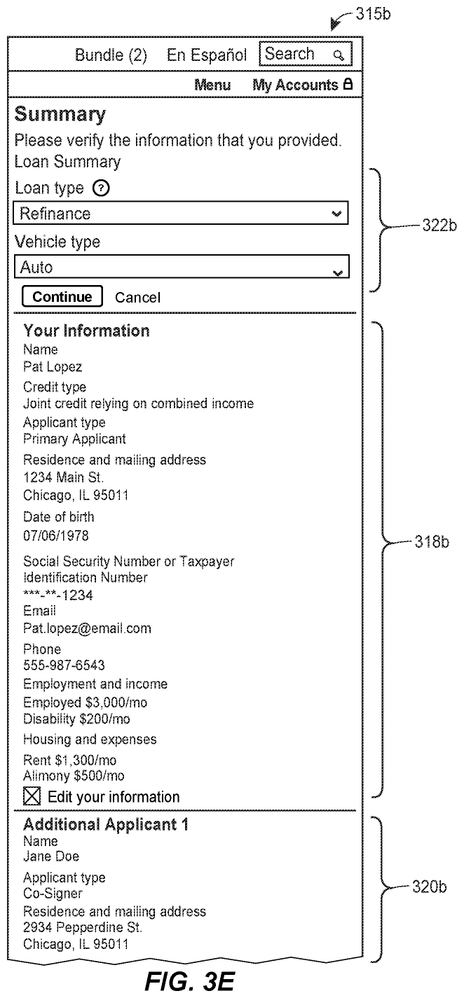

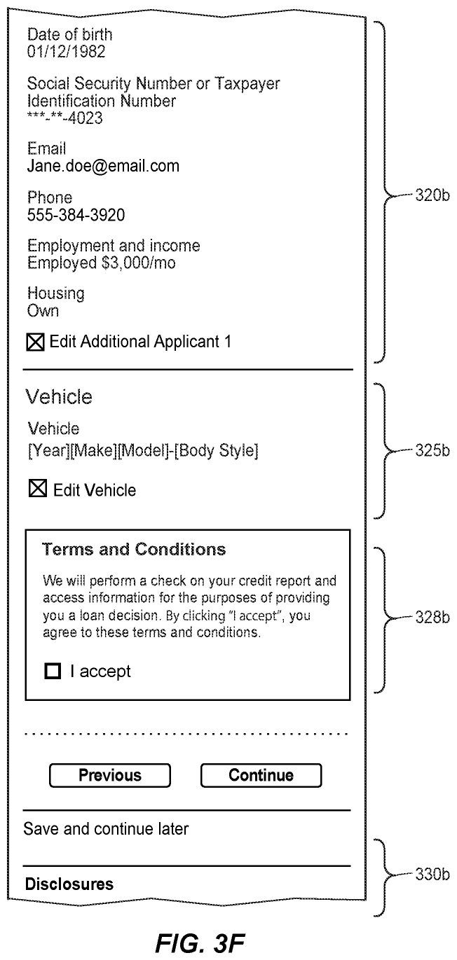

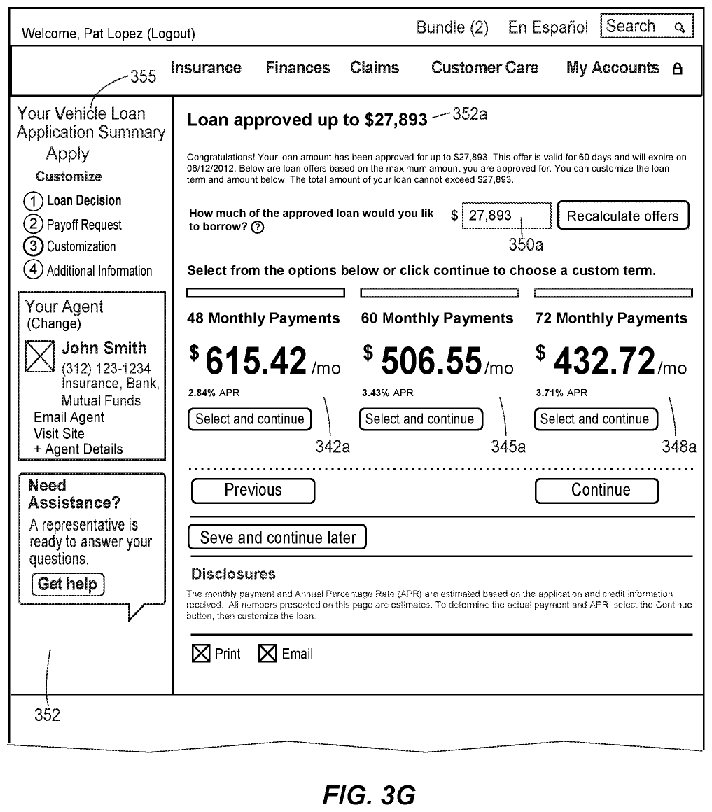

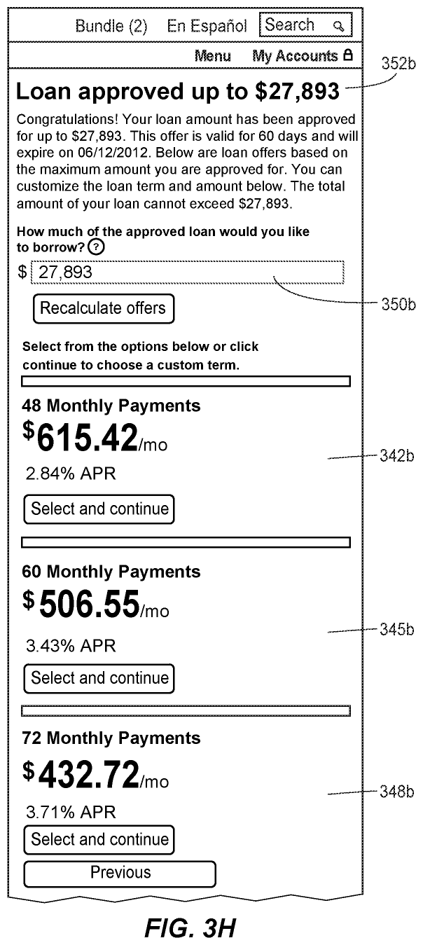

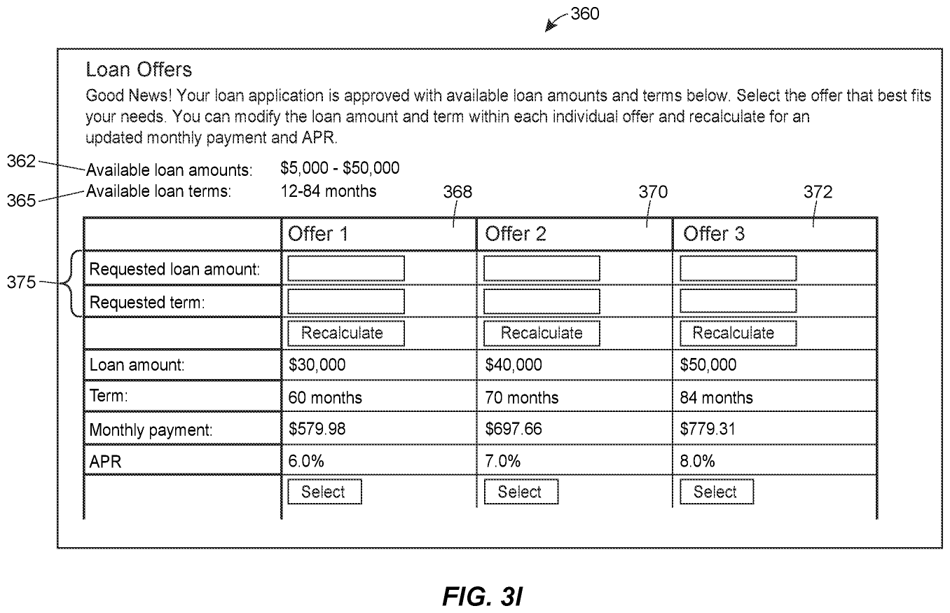

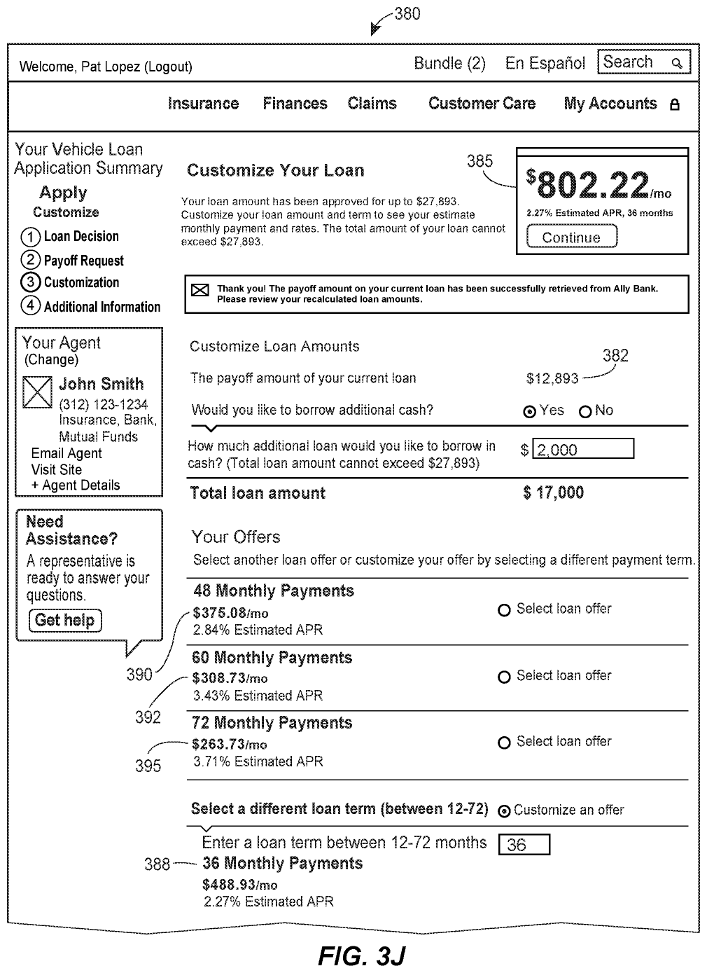

FIGS. 3A-3J include a set of exemplary user interface screens which may be presented at one or more user interface channels, e.g., one or more of the multiple user interface channels provided by the system 200 of FIG. 2, such as by using the devices 202, 240, 242, 245 and/or 250. In a present embodiment, the loan application process provider 208 of the system 200 may cause at least some of the screens to be presented at a user interface in communicative connection with a user interface channel provided by the system 200. In a present embodiment, at least some of the user interface screens of FIGS. 3A-3J may be generated by the method 100 of FIG. 1. Of course, any number of any of the screens may be generated by methods other than the method 100 and/or by systems other than the system 200. However, for ease of discussion and not for limitation, FIGS. 3A-3J are discussed below with simultaneous reference to FIGS. 1 and 2.

Turning first to FIG. 3A, the loan application process provider 208 may cause an account access screen 302a to be presented on a user interface of a computing device. For example, the screen 302a may be presented on a user interface of a computing device of a loan applicant (reference 250), or on a user interface of a computing device of an agent of an institution providing the loan application process (reference 240, 242). Via the screen 302a, a loan applicant may create an account 235x via which the applicant may initiate, monitor, and/or access the loan application process, e.g., from initiating the loan application to providing modifications to offers, providing additional loan information, receiving an indication of a final loan approval or denial, and/or closing an approved loan offer. The account 235x may be secured to the applicant using any suitable security and/or authentication mechanism. For example, as shown in FIG. 3A, the applicant's account 235x may be secured using a login 305 and a password 308. Additionally, as the screen 302a of FIG. 3A may be suitable for a laptop or desktop user interface, the screen 302a may include one or more additional user interface and/or user control fields, such as a help link 310.

As previously discussed, though, the applicant may access his or her account 235x by using any of a multiplicity of user interface channels. As such, FIG. 3B illustrates an example configuration 302b of an account access screen that is designed for presentation on a user interface of a computing device having a smaller display area than that of the computing device on which the account access screen 302a of FIG. 3A may be presented. For example, the screen 302b may be presented on a mobile device (i.e., smart phone, cell phone, phablet, tablet, computing device, laptop, wearable electronic device, smart watch, smart contact lenses, desktop computer, netbook, personal digital assistant (PDA), smart glasses, pager, text messaging device, hand held communications device, and/or other device capable of one-way or two-way wireless communication). The screen 302b may include similar information as included on the screen 302a (e.g., user login field 305 and password field 308), however, one or more of the additional user interface and/or control fields 310 may be omitted, and/or may be presented at a different location on the visible screen 302b. For example, a user may be required to scroll or open a new window to view additional user interface and/or control fields 310 (not illustrated).

FIGS. 3C-3D illustrate an exemplary user interface screen 315a via which a user may provide, enter, and/or modify loan application information. For example, the screen 315a may be presented on a user interface of a computing device of a loan applicant (reference 250), and/or on a user interface of a computing device of an agent of an institution providing the loan application process (reference 240, 242). In FIG. 3C, the user has already entered personal information for a primary applicant 318a and for a co-signer 320a, and the user is in the process of selecting loan information 322a (e.g., a loan type and/or a vehicle type). The interface screen 315a (continued onto FIG. 3D) may include a portion 325a via which the user may enter vehicle information. In some embodiments, the interface screen 315a may include a portion 328a via which the user may signify his or her acceptance of the terms and conditions of the loan application process, and a portion 330a via which disclosures (e.g., legal disclosures, etc.) are provided. Additionally, as the screen 315a of FIGS. 3C-3D illustrates an exemplary configuration which may be suitable for a laptop or desktop user interface, the screen 315a may include one or more additional user interface and/or user control fields, e.g., a summary portion 332.

Typically, information and/or data corresponding to the applicant's account 235x (e.g., login/password 305, 308, personal information 318, 320, vehicle information 325, loan information 322, application status information, supporting documentation, other information 328, 330, etc.) may be stored and/or maintained in the data storage area 222. For example, data provided via the screen 315a may be stored in the data storage area 222 in conjunction with the applicant's account 235x, and may be accessible only after a user has been authenticated to the created account 235x.

FIGS. 3E-3F illustrate an exemplary configuration 315b of a loan application information screen that is designed for presentation on a user interface of a computing device having a smaller display area than that of a computing device on which the screen 315a of FIG. 3C may be presented. For example, the screen 315b may be presented on a mobile device (e.g., smart phone, a tablet, etc.). The screen 315b may include similar information as the screen 315a (e.g., personal information 318b, 320b, vehicle information 325b, loan information 322b, terms and conditions 328b, and/or disclosure information 330b), however, one or more of the additional user interface and/or control fields 332 may be omitted, and/or may be presented at a different location on the visible screen 315b. For example, a user may be required to scroll or open a new window to view additional user interface and/or control fields 322 (not shown).

Generally, the loan application information screen 315a, 315b may allow a user to enter, review, and/or edit loan application information. Additionally, in some embodiments, the loan application information screen 315a, 315b may notify a user of disclosures and statuses of various portions of the application process, e.g., credit checks, receipt of supporting documentation or evidence, etc. Further, at least some of the information and user interfaces provided by the loan application information screen 315 may be provided at any or all of the multiple user interface channels of the system 200. For example, the screen 315a and/or the screen 315b may be presented on the computing device of an agent 240, on the computing device of a call center agent 242, and/or on a computing device of the user and/or applicant 250. If the user desires, at least some of the loan application information may be received via the channel(s) at which the screen 315a and/or the screen 315b was presented. In another example, the loan application may be presented and at least some of the loan application information may be received manually, e.g., at an agent's office or via the mail or postal service. Of course, the loan application information may be presented and/or received by the loan application process provider 208 via multiple different user interface channels, if the user desires.

FIG. 3G illustrates an exemplary user interface screen 340a via which a plurality of loan offers corresponding to the initial loan application may be presented. For example, the screen 340a may be presented on a user interface of a computing device of the loan applicant (reference 250), and/or on a user interface of a computing device of an agent of an institution providing the loan application process (reference 240, 242). The screen 340a may include a respective indication of each of a plurality of loan offers 342a, 345a, 348a. In the case illustrated in FIG. 3G, each of the loan offers 342a, 345a, 348a is for a same loan amount, e.g., a desired loan amount of $27,893 indicated by the user (reference 350a). However, in some cases, one or more offers for different loan amounts may be indicated on the screen 340a. For example, respective loan offers for borrowing $10,000, $20,000 and $27,893 may be provided on the screen 340a.

As shown in FIG. 3G, each loan offer 342a, 345a, 348a may include an indication of a corresponding loan term (e.g., 48 months, 60 months, and 72 months, respectively). Additionally, each loan offer 342a, 345a, 348a may include an indication of a corresponding monthly or periodic payment amount (e.g., $194.40, $178.40, and $147.49, respectively), and/or an indication of a corresponding APR or annual percentage rate (e.g., 2.84% APR, 3.43% APR, and 3.71% APR, respectively). In some embodiments, the loan offers screen 340a may include an indication of a maximum loan amount 352a that has been approved based upon the single loan application, and may include a user control 350a via which the user may enter a desired loan amount. In some embodiments, each loan offer 342a, 345a, 348a may include an indication of a different loan amount (not shown in FIG. 3E, as all three offers 342a, 345a, 248a are for the same desired amount 350a of $27,893).

Some or all of the information 342a, 345a, 348a, 352a included on the loan offers screen 340a may have been determined based upon the underwriting of the single loan application, e.g., based upon the loan application information received via the screens 315a and/or 315b. The screen 340a may optionally include other information 355. For example, in FIG. 3G, a loan application summary 355 may be presented in conjunction with the loan offers information 342a, 345a, 348a, and may indicate the present stage of the particular loan application associated with the applicant's account 235x.

FIG. 3H illustrates an exemplary user interface screen 340b via which a plurality of loan offers corresponding to the initial loan application may be presented. In FIG. 3H, the screen 340b may presented on a user interface of a computing device having a display area that is smaller than that of the computing device of FIG. 3G (e.g., a tablet or a smart phone or device). Similar to the screen 240a, the screen 240b may include respective indications of a plurality of loan offers 342b, 345b, 348b. Further, each loan offer 342b, 345b, 348b may include a corresponding indication of a loan term (e.g., 48 months, 60 months, and 72 months, respectively). Additionally, each loan offer 342b, 345b, 348b may include a corresponding indication of a monthly or periodic payment amount (e.g., $194.40, $178.40, and $147.49, respectively), and/or a corresponding indication of an APR or annual percentage rate (e.g., 2.84% APR, 3.43% APR, and 3.71% APR, respectively). In some embodiments, the loan offers screen 340b may include an indication of a maximum loan amount 352b that has been approved for the loan application, and a user control 350b via which the user may enter a desired loan amount. In some embodiments, each loan offer 342b, 345b, 348b may include an indication of a respective loan amount (not shown in FIG. 3H, as all three offers 342b, 345b, 348b are for the same user indicated amount 350b of $27,893). Some or all of the information 342b, 345b, 348b, 352b included on the loan offers screen 340b may have been determined based upon the underwriting of the single loan application, e.g., based upon the loan application information received via the screens 315a and/or 315b. In the screen 340b, though, the one or more of the additional user interface and/or control fields 355 which are included in the screen 340a may be omitted from the screen 340b, and/or may be presented at a different location on the visible screen area 340b. For example, a user may be required to scroll or open a new window to view additional user interface and/or control fields 355 (not shown).

At least some of the information and user interfaces provided by the loan offers screen 340 may be provided at any or all of the multiple user interface channels of the system 200. For example, the screen 340a, 340b may be presented on the computing device of an agent 240, on the computing device of a call center agent 242, and/or on a computing device of the user or applicant 250. In another example, the applicant may receive at least some of the loan offers information 340a, 340b manually, e.g., at an agent's office or via the postal service. Of course, the loan offers information may be provided by the loan application process provider 208 to the applicant via multiple different user interface channels, if the user desires.

FIG. 3I illustrates an exemplary user interface screen 360 via which a user may customize and/or modify one or more offer parameters of one or more of the presented loan offers, e.g., the offers presented on the screens 340a, 340b. Similar to the previously discussed screens of FIGS. 3A-3H, the information presented on the loan customization screen 360 may be presented at a display of a stationary or mobile computing device, and the configuration of the screen 360 may be modified for a particular display area accordingly. However, for simplicity of discussion, only one configuration of the screen 360 is included in FIG. 3I. As seen in FIG. 3I, the screen 360 may include an indication of a range of approved loan amounts 362 for the single loan application, and may include an indication of a range of approved loan terms 365 for the single loan application. The user interface screen 360 may also include indications of multiple approved loan offers 368, 370, 372. In FIG. 3I, each loan offer 368, 370, 372 indicates a different loan amount (e.g., $30,000, $40,000, and $50,000, respectively), although the user customization screen 360 may include thereon multiple loan offers for a same loan amount, in some loan application scenarios. Additionally, each loan 368, 370, 372 may indicate a corresponding loan term (e.g., 60 months, 70 months, and 84 months, respectively), a corresponding monthly payment (e.g., $579.85, $681.96, and $779.31, respectively), and a corresponding APR (e.g., 6.0%, 7.0%, and 8.0%, respectively). As previously discussed, the offers 368, 370, 372 and the additional offer information 362, 365 may have been determined based upon the underwriting of the single loan application.

The loan customization user interface screen 360 may further include respective user controls 375 via one or more offer parameters of each loan offer may be modified and/or customized by a user. For example, the user may be allowed to enter a modified value of a loan amount within the approved range 362, a modified value of a loan term within the approved range 365, and/or one or more other offer parameters (not shown) for each loan offer 368, 370, 372, as desired. After the user has entered one or more customizations and/or modifications to one or more selected offer parameters of a particular loan offer, the loan application process provider 208 may automatically update the other offer parameters of the particular loan offer accordingly. For example, if a user decreases a loan term of the Offer 1 (reference 368), the monthly payment of Offer 1 may automatically be updated to a corresponding increased value. If a user decreases a loan amount of Offer 3 (reference 372), the monthly payment of Offer 3 may automatically be updated to a corresponding decreased value. A user may modify one or more offer parameters of one or more loan offers, as he or she desires, to customize one or more loan offers, and a user may select one of the loan offers (which may include one or more offer parameters modified by the user) with which to proceed.

Similar to as previously discussed, at least some of the information and user interfaces provided by the loan customization screen 360 may be provided at any or all of the multiple user interface channels of the system 200. For example, the screen 360 may be presented on the computing device of an agent 240, on the computing device of a call center agent 242, and/or on a computing device of the user or applicant 250. In some scenarios, at least some of the loan customizations and/or modifications may be received via the channel(s) at which the screen 360 was presented. In another scenario, an applicant may provide at least some of the loan customizations and/or modifications manually at an agent's office or via the postal service, even though previous loan application steps were performed electronically. Of course, the loan customizations and/or modifications may be received by the loan application process provider 208 from the applicant via multiple different manual and/or electronic user interface channels, as the user desires.

In addition to being updated based upon user modifications, one or more loan offers may be updated based upon other, additional received information such as verification information and/or supporting documentation. For example, for a vehicle refinance loan, a private party loan, or a lease buyout, a payoff amount of an existing loan or lease may be required to be received and/or verified by the holder of the existing loan or lease. In an embodiment, a user may provide, to the loan application process provider 208, an indication of a holder of the existing lease or loan, contact information of the holder, and/or an identification of the existing lease or loan (e.g., lease or loan account number, applicant identification information, etc.). For example, the existing loan or lease information may be provided via the loan application information screen 315 and/or via another user interface screen. The loan application process provider 208 may initiate communication with the provider of the existing lease or loan (either electronically, manually, or both) to receive and/or verify the payoff amount of the existing lease or loan. Upon receipt and/or verification of the payoff amount, the loan application process provider 208 may automatically update one or more offer parameters of one or more of the multiple loan offers based upon the received and/or verified payoff amount, and may present the updated loan offers to the user, e.g., via a user interface screen 380 as shown in FIG. 3J.

In FIG. 3J, the updated loan offers user interface screen 380 may include an indication of a verified payoff amount 382 of an existing loan or lease of the applicant, e.g., the payoff amount 382 may have been provided and/or verified by the providing institution of the existing loan or lease, and/or by another party. Additionally, the user interface screen 380 may include an indication of the initially or currently selected loan offer (reference 385). However, on the updated loan offers screen 380, the value of one or more offer parameters of the currently selected loan offer 385 may have been updated, based upon the received payoff amount 382, to generate an updated loan offer 385. For example, if the verified payoff amount 382 is greater than initially indicated prior to verification (e.g., indicated via the loan application information screen 315 or some other screen), the updated loan offer 385 may have a lower monthly payment value and/or a shorter term as compared to the parameter values provided prior to verification of the payoff amount. Additionally, the screen 380 may include one or more user controls 388 via which the user may further modify, customize, and/or select the updated loan offer 385, e.g., in a manner such as previously discussed.

In some embodiments, the updated loan offers user interface screen 380 may also include one or more other loan offers 390, 392, 395 that may be based upon the additional received information, e.g., the verified payoff amount 382. Similar to the loan offers 342, 345, 348, 368, 370, 372 provided prior to the verification of the payoff amount, each of the loan offers 390, 392, 395 may indicate a respective loan amount, loan term, loan payment, and/or APR. In some cases, one or more of the loan offers 390, 392, 395 may be generated based upon a previously provided offer 342, 345, 348, 368, 370, 372 and/or the additional received information, e.g., the verified payoff amount 382. In some cases, one or more of the loan offers 390, 392, 395 may be a newly generated loan offer based upon the received information 382. Additionally, the user interface screen 380 may provide one or more user controls for each of the other loan offers 390, 392, 395 via which the user may further modify, customize, and/or select the updated loan offer 385 and/or any of the other loan offers 390, 392, 395, e.g., in a manner such as previously discussed. Further, also in a manner such as previously discussed, the information presented on the screen 380 may be presented at a display of a stationary or mobile computing device, and the configuration of the screen 380 may be modified for a particular display area accordingly. Still further, in a manner such as previously discussed, some of all of the contents and/or user controls the screen 380 may be presented to the applicant via any user interface channel provided by the system 200, and/or by multiple user interface channels provided by the system 200.

Referring still to the updated loan offers screen 380 of FIG. 3J, if the payout amount 382 is greater than user-desired/indicated loan amount 350 for the loan application (which in some cases, may be the maximum loan amount 352), cash out or an equivalent electronic funds transfer may be provided to the user at closing. If the payout amount 382 is less than the desired/indicated loan amount 350, the user may be required to provide cash in or an equivalent electronic funds transfer in order to close the loan. For example, to close the loan, cash in may be provided via an EFT from another account of the applicant, a physical or electronic check, via an automated clearing house, a credit or debit card, an electronic payment service such as PayPal, certified funds, or the like. Similarly, if needed, cash out may be provided via an EFT to another account of the applicant, a physical or electronic check, via an automated clearing house to an account of the applicant and/or to the vehicle dealer, an electronic payment service, or the like.

Indeed, closing the loan (e.g., block 138 of FIG. 1) may be performed using any number of the multiple user interface channels provided by the system 200. For example, the loan may be closed 138 via one or more direct electronic user interface channels, such as via a website 245 and/or user computing device 250. Additionally or alternatively, the loan may be closed 138 via one or more indirect electronic interface channels, such as at an agent's computing device and/or office 240, and/or via a call center representative 242. In some situations, the loan may be closed 138 in a traditional manner, e.g., with the applicant and the agent (and/or their respective agents) meeting face-to-face. In some situations, the loan may be closed 138 using more than on user interface channel. The loan may be closed 138, for example, using any number of any of the user interface channels, as desired by the user.

In some embodiments, closing the loan 138 may include obtaining an electronic signature of the applicant (or an agent thereof) and/or an electronic signature of an agent of the providing institution. For example, the applicant may provide an electronic signature via a keyboard or a touch screen of his or her computing device 250, which may be then delivered to the loan application process provider 208 to close the loan. Alternatively, an image, fax, or pdf of an applicant's wet signature may be transmitted to the loan application process provider 208, e.g., via the applicant's computing device 250 and/or via an agent's computing device 240, 242. Similarly, images, faxes, and/or pdfs of other supporting documentation (for example, scan of applicant's photo identification, proof of income, vehicle registration documentation, etc.) may be provided to the loan application process provider 208, e.g., via the applicant's computing device 250 and/or via an agent's computing device 240, 242. All electronic documents and/or information that is received for the loan application 235x may be stored, e.g., in the data storage 222, and may be accessible by the loan application process provider 208. For example, the applicant and/or an agent of the providing institution may request the loan application process provider 208 to view one or more of the stored documents and/or information.

It is noted that at any time during the loan application process, from initiation of the loan application to either of its closing or denial, the applicant may access his or her account 235x to ascertain its current status. For example, the account 235x may have a status of “pending underwriting” or “pending payoff verification.” Further, in some embodiments, if interest rates change or decrease during the loan application process, the next time the user or applicant accesses his or her account 235x after the interest rate change or decrease, updated loan offers based upon the changed or lower interest rates may be automatically determined and/or presented, e.g., on the updated loan offers screen 380. An indication of the lower interest rates and any updated parameters may be indicated on the screen 380.

As such, the method 100 and/or the system 200 may automatically re-price and/or update initially provided loan offers based upon user modifications and/or customizations, based upon the content of received third party information (e.g., payout or payoff amounts), and/or changes in market conditions, as well as other factors. In an embodiment, the method 100 and/or the system 200 may automatically re-price and/or update loan offers corresponding to the applicant's account 235x each time the account 235x is re-accessed by a user.

Turning now again back to FIG. 2, while the providing institution computing device 202, the data storage device 222, the agent computing devices 240, the call center computing devices 242, the website/portal/remote application host 245, the gateway and/or firewall 255, and the providing institution network 232 are illustrated as separate and distinct entities, this is only one of many embodiments. Any number of any of the devices 202, 222, 240, 242, 245, 255 may be included in the network 232, for example. Additionally or alternatively, any number of any of the devices 202, 222, 240, 242, 245, 255 may be a combined or integral device. For example, the providing institution computing device 202 may host the website(s) and/or portal(s) 245 of the providing institution, and/or the firewall 255 may be incorporated into each agent computing device 240 and/or into the website/portal/remote application host 245.

With particular regard to the providing institution computing device 202, in addition to the loan application process provider 208, the program memory 205 may store thereon further computer-readable or computer-executable instructions 265 that further particularly configure the computing device 202 and that may be executed in conjunction with the loan application process. For example, the other instructions 265 may execute to cause the computing device 202 to authorize and/or validate access of agents of the providing institution and/or of loan applicants. The other instructions 265 may manage the downloading and/or provision of client applications 258 to client computing devices 250. The other instructions 265 may store connectivity, status, and/or identification information of external institution computing devices 260, e.g., from which verification and/or provision of existing loans and/or leases may be obtained, and/or from which EFTs may be sent and/or received. Other functions corresponding to the loan application process may be performed by the instructions 265. In some embodiments, at least a portion of the instructions 265 may be integral with at least a portion of the loan application process provider instructions 208.

Further, with regard to the computing device 202, while the loan application process provider 208 is shown as a single block in FIG. 2, it will be appreciated that the loan application process provider 208 may include any number of different programs, modules, routines, and/or sub-routines that may collectively cause the computing device 202 to implement the loan application process provider 208. Similarly, while the other instructions 265 is shown as a single block, it will be appreciated that the other instructions 265 may include a number of different programs, modules, routines, and/or sub-routines that may collectively cause the computing device 202 to implement the other instructions 265.

Still further, it should be appreciated that although only one processor 210 is shown, the computing device 202 may include multiple processors 210. Additionally, although the I/O circuit 215 is shown as a single block, it should be appreciated that the I/O circuit 215 may include a number of different types of I/O circuits. Similarly, the memory of the computing device 202 may include multiple RAMs 212 and/or multiple program memories 205. Further, while the instructions 208 for providing a loan application process and/or the other instructions 265 are shown being stored in the program memory 205, the instructions may additionally or alternatively be stored in the RAM 212 and/or other suitable local memory (not shown).

The RAM(s) 212 and/or program memories 205 may be implemented as semiconductor memories, magnetically readable memories, chemically or biologically readable memories, and/or optically readable memories, and/or may utilize any suitable memory technology or technologies. The computing device 202 may also be operatively connected to the network 232 via the link 230 and the I/O circuit 215, in some embodiments.

Moreover, although the foregoing text sets forth a detailed description of numerous different embodiments, it should be understood that the scope of the patent is defined by the words of the claims set forth at the end of this patent. The detailed description is to be construed as exemplary only and does not describe every possible embodiment because describing every possible embodiment would be impractical, if not impossible. Numerous alternative embodiments could be implemented, using either current technology or technology developed after the filing date of this patent, which would still fall within the scope of the claims. By way of example, and not limitation, the disclosure herein contemplates at least the following aspects indicated below.

### VI. EXEMPLARY COMPUTER-IMPLEMENTED METHOD

In one aspect, a computer-implemented method of providing a loan application process for purchasing a vehicle may be provided. The method may include (1) receiving, at one or more computing devices, application information for a single loan application to purchase a vehicle. The application information may include personal information corresponding to an applicant and vehicle information indicative of the vehicle, and the application information excluding an amount of the loan and excluding a term of the loan. The method may include (2) providing, by the one or more computing devices, the received application information for underwriting; (3) receiving, at the one or more computing devices, a plurality of loan offers corresponding to the single loan application and determined based upon the underwriting, each loan offer including respective offer information, and the respective offer information including a respective value of one or more offer parameters from a plurality of offer parameters, the plurality of offer parameters including a loan amount, a loan term, an annual percentage rate (APR), and a periodic payment amount; (4) causing, by the one or more computing devices, indications of the plurality of loan offers to be presented at a user interface; and/or (5) receiving, by the one or more computing devices, an indication of a user selection of one of the plurality of loan offers, the user selection received via the user interface. The method may include additional, fewer, or alternate actions, including those discussed elsewhere herein.

For instance, providing the received application information for underwriting comprises providing the received application information for underwriting using a plurality of underwriting models; and the plurality of underwriting models may include an underwriting and/or scoring model.

Receiving the plurality of loan offers corresponding to the application information may include receiving a plurality of approved loan offers corresponding to the application information. The method may further include causing an indication of a range of approved values of a particular offer parameter to be presented at the user interface. Causing the indications of the plurality of loan offers to be presented at the user interface may include causing an indication of at least one loan offer to be presented in conjunction with an offer for a disability insurance policy for the loan offer.

Receiving the indication of the user selection of the one of the plurality of loan offers may include receiving an indication of a user modification to a value of a particular offer parameter included in the one of the plurality of loan offers. The method may also include modifying, based upon the user modification, a value of another offer parameter included in the one of the plurality of loan offers; and/or closing, at the one or more computing devices, a loan corresponding to the selected one of the loan offers, including at least one of: receiving, at the one or more computing devices, an electronic signature of the applicant; receiving, at the one or more computing devices, an electronic funds transfer corresponding to the accepted loan offer; and/or electronically initiating, by the one or more computing devices, a disbursement of an amount of funds corresponding to the accepted loan offer.

The one or more computing devices may include (i) a mobile device storing a client application, and (ii) a back-end computing device hosting a website or a server application. A first portion of the method may be performed by the client application executing on the mobile device; and a second portion of the method may be performed by the website or the server application hosted on the back-end computing device.

The method may include automatically updating, by the one or more computing devices, the plurality of loan offers based upon a change in interest rates; and causing indications of the updated plurality of loan offers to be presented at the user interface. The method may further include receiving a user selection of one of the updated plurality of loan offers.

### VII. EXEMPLARY COMPUTER SYSTEM

In one aspect, a system for providing a loan application process for purchasing a vehicle may include one or more computing devices operated by a user. The one or more computing devices may include one or more processors, one or more communication interfaces, a user interface, and one or more memory or data storage devices. The one or more memory or data storage devices may store a particular set of computer-executable instructions that particularly configure the system to, when the particular set of computer-executable instructions is executed by the one or more processors, (1) receive, at least in part via the user interface, application information for a single loan application to purchase a vehicle. The application information may include personal information corresponding to an applicant and vehicle information indicative of the vehicle, and the application information may exclude an amount of the loan and a term of the loan. Further, the particular set of computer-executable instructions may particularly configure the one or more computing devices further to (2) transmit, via the one or more communication interfaces, the received application information for underwriting; and (3) receive, via the one or more communication interfaces, a plurality of loan offers corresponding to the single loan application and determined based upon the underwriting, where each loan offer includes respective offer information, the respective offer information includes a respective value of one or more offer parameters from a plurality of offer parameters, and the plurality of offer parameters includes a loan amount, a loan term, an annual percentage rate (APR), and a periodic payment amount. The particular set of computer-executable instructions may particularly configure the one or more computing devices still further to: (4) present indications of the plurality of loan offers at a user interface; and (5) receive, via the user interface in response to the presented plurality of loan offers, an indication of a user selection of one of the plurality of loan offers. The particular set of computer-executable instructions may particularly configure the one or more computing devices further to perform additional, fewer, or alternate actions, including those discussed elsewhere herein.

For instance, the transmission of the received application information for underwriting may comprise a transmission of the received application information for underwriting using a plurality of underwriting models. The plurality of underwriting models may include an underwriting and/or scoring model.

The plurality of loan offers corresponding to the application information and determined based on the underwriting may include a plurality of approved loan offers corresponding to the application information. Additionally, the particular set of computer-executable instructions may further particularly configure the one or more computing devices to present an indication of a range of approved values of a particular offer at the user interface. In some embodiments, the presented indications of the plurality of loan offers at the user interface may include an indication of at least one loan offer presented in conjunction with an offer for a disability insurance policy for the at least one loan offer.

The indication of the user selection of the one of the plurality of loan offers may include an indication of a user modification to a value of a particular offer parameter included in the one of the plurality of loan offers. Additionally, the particular set of computer-executable instructions may further particularly configure the one or more computing devices to modify, based upon the user modification, a value of another offer parameter included in the one of the plurality of loan offers; and/or to close a loan corresponding to the selected one of the loan offers. Closing the loan may include at least one of: receiving an electronic signature of the applicant; receiving an electronic funds transfer corresponding to the accepted loan offer; and/or electronically initiating a disbursement of an amount of funds corresponding to the accepted loan offer.

The one or more computing devices may include (i) a mobile device storing a client application, and (ii) a back-end computing device hosting a website or a server application. A first portion of the particular set of computer-executable instructions may be performed by the client application executing on the mobile device; and a second portion of the computer-executable instructions may be performed by the website or the server application hosted on the back-end computing device.

The particular set of computer-executable instructions may further particularly configure the one or more computing devices to automatically update the plurality of loan offers based upon a change in interest rates; and present indications of the updated plurality of loan offers at the user interface. The particular set of computer-executable instructions may further particularly configure the one or more computing devices to receive a user selection of one of the updated plurality of loan offers.

### VIII. ANOTHER EXEMPLARY COMPUTER SYSTEM

In one aspect, a system for providing loan application processes for purchasing vehicles may be provided. The system may include computer-executable instructions stored on one or more tangible, non-transitory memories, wherein an execution of the computer-executable instructions by one or more processors causes the system to perform the computer-implemented method mentioned above and/or alternate actions.

The system may include a loan application process provider comprising computer-executable instructions stored on one or more tangible, non-transitory memories, the loan application process provider communicatively connected to a plurality of user interface channels. The plurality of user interface channels may include: (i) a local application executing on a mobile device accessible to a user; and (ii) a website or remote application hosted by a back-end computing device. The computer-executable instructions of the loan application process provider, when executed by one or more processors, may cause the system to: (a) receive loan application information corresponding to an application for a loan to purchase a vehicle, the loan application information including personal information corresponding to a loan applicant and vehicle information indicative of the vehicle, and the loan application information excluding an amount of the loan and excluding a term of the loan; (b) cause one or more loan offers to be presented at a user interface, the one or more loan offers determined based upon underwriting of the loan application information, and each loan offer including respective offer information; (c) receive a user selection of a particular loan offer from the one or more loan offers; and/or (d) close a loan corresponding to the particular loan offer. The loan application process provider may perform at least one of (a)-(d) by using a first user interface channel of the plurality of user interface channels, and the loan application process provider may perform at least one other of (a)-(d) using a second user interface channel of the plurality of user interface channels.

The plurality of user interface channels may include a call center, an office of an agent of a provider of the loan, and/or a computing device used by the agent of the provider of the loan. The loan application process provider may be configured to perform any one of (a)-(d) mentioned directly above by using any one of the plurality of user interface channels. The loan application process provider may close the loan by using the local application executing on the mobile device or by using the website or remote application hosted by the back-end computing device.

An electronic digital signature of the applicant may be received via the local application executing on the mobile device or via the website or remote application hosted by the back-end computing device to close the loan. The respective offer information may include one or more offer parameters from a set of offer parameters including a loan amount, a loan term, an amount of a periodic loan payment, and an annual percentage rate (APR).

The user selection of the particular loan offer may include a user modification to a value of a particular offer parameter included in the particular loan offer; and the computer-executable instructions of the loan application process provider, when executed by the one or more processors, may cause the system to further update a value of at least one other offer parameter included in the particular loan offer based upon the user modification, and cause the updated value of the at least one other offer parameter to be presented at the user interface.

The computer-executable instructions of the loan application process provider, when executed by the one or more processors, may cause the system further to electronically transfer funds corresponding to the close of the loan. The electronic transfer of funds may include at least one of a disbursement of funds or a reception of funds; and the electronic transfer of funds uses at least one of an automated clearing house, an electronically-generated check, an internal transfer, or certified funds. The one or more loan offers may include one or more approved loan offers that are each modifiable within a set of approved ranges. The system may include additional, fewer, or alternate components and/or provide additional, less, or alternate functionality, including that discussed elsewhere herein.

### IX. ADDITIONAL CONSIDERATIONS

Additionally, certain embodiments are described herein as including logic or a number of functions, components, modules, blocks, or mechanisms. Functions may constitute either software modules (e.g., non-transitory code or instructions stored on a tangible, non-transitory machine-readable storage medium) or hardware modules. A hardware module is a tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain functions. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term hardware should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware and software modules can provide information to, and receive information from, other hardware and/or software modules. Accordingly, the described hardware modules may be regarded as being communicatively coupled. Where multiple of such hardware or software modules exist contemporaneously, communications may be achieved through signal transmission (e.g., over appropriate circuits and buses) that connect the hardware or software modules. In embodiments in which multiple hardware modules or software are configured or instantiated at different times, communications between such hardware or software modules may be achieved, for example, through the storage and retrieval of information in memory structures to which the multiple hardware or software modules have access. For example, one hardware or software module may perform an operation and store the output of that operation in a memory device to which it is communicatively coupled. A further hardware or software module may then, at a later time, access the memory device to retrieve and process the stored output. Hardware and software modules may also initiate communications with input or output devices, and can operate on a resource (e.g., a collection of information).

The various operations of example functions and methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or functions described herein may be at least partially processor-implemented. For example, at least some of the functions of a method may be performed by one or processors or processor-implemented hardware modules. The performance of certain of the functions may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the functions may be performed by a group of computers (as examples of machines including processors), these operations being accessible via a network (e.g., the Internet) and via one or more appropriate interfaces (e.g., application program interfaces (APIs).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data and data structures stored as bits or binary digital signals within a machine memory (e.g., a computer memory). These algorithms or symbolic representations are examples of techniques used by those of ordinary skill in the data processing arts to convey the substance of their work to others skilled in the art. As used herein, a “method” or a “function” or an “algorithm” or a “routine” is a self-consistent sequence of operations or similar processing leading to a desired result. In this context, methods, functions, algorithms, routines and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments” or “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a function, process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description should be read to include one or at least one and the singular also includes the plural unless it is obvious that it is meant otherwise.

Still further, the figures depict preferred embodiments of a computer system 202 for purposes of illustration only. One of ordinary skill in the art will readily recognize from the following discussion that alternative embodiments of the structures and methods illustrated herein may be employed without departing from the principles described herein.

Upon reading this disclosure, those of skill in the art will appreciate still additional alternative structural and functional designs for a system and method of providing a flexible vehicle loan application process through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

1. A method of providing a loan application process for financing a vehicle, the method comprising:
receiving, at one or more computing devices, and via wired or wireless communication and/or data transmission, application information for a single loan application to finance a vehicle, the application information including personal information corresponding to an applicant and vehicle information indicative of the vehicle, and the application information excluding an amount of the loan and excluding a term of the loan;
providing, by the one or more computing devices, and via wired or wireless communication and/or data transmission, the received application information for underwriting;
receiving, by the one or more computing devices, an indication of an underwriting approval of the application information;
receiving, at the one or more computing devices, and via wired or wireless communication and/or data transmission, (i) a plurality of loan offers corresponding to the single loan application and determined based on the indication of the underwriting approval, each loan offer including respective offer information, and the respective offer information including a plurality of offer parameters, the plurality of offer parameters including a loan amount, a loan term, an annual percentage rate (APR), and a periodic payment amount, and (ii) a range of values for an offer parameter of the plurality of offer parameters;
causing, by the one or more computing devices, and via wired or wireless communication and/or data transmission, indications of the plurality of loan offers to be presented at a user interface;
causing, by the one or more computing devices, and via wired or wireless communication and/or data transmission, indications of (i) the range of values for the offer parameter and (ii) a current value of the offer parameter to be presented at the user interface;
receiving, by the one or more computing devices, and via wired or wireless communication and/or data transmission, an indication of a user modification of the current value to be within the range of values;
causing, by the one or more computing devices, indications of one or more updated loan offers according to the modification of the current value, to be presented at the user interface; and
receiving, by the one or more computing devices, and via wired or wireless communication and/or data transmission, an indication of a user selection of one of the plurality of loan offers or one or more updated loan offers, the user selection received via the user interface.

2. The method of claim 1, wherein receiving the plurality of loan offers corresponding to the single loan application comprises receiving a plurality of approved loan offers corresponding to the application information.

3. The method of claim 1, further comprising:
receiving, by the one or more computing devices, and via wired or wireless communication and/or data transmission, an indication of a user selection of a value outside of the range of values of at least one offer parameter;
updating a range of values of at least one other offer parameter included in the particular loan offer based on the user modification, and
causing the updated range of values of the at least one other offer parameter to be presented at the user interface.

4. The method of claim 1, wherein causing the indications of the plurality of loan offers to be presented at the user interface comprises causing an indication of at least one loan offer to be presented in conjunction with an offer for an individual credit disability insurance policy for the loan offer.

5. The method of claim 1, wherein receiving the indication of the user modification of one of the plurality of loan offers or one or more updated loan offers comprises receiving an indication of a user modification to a value of a particular offer parameter included in the one of the plurality of loan offers or one or more updated loan offers.

6. The method of claim 5, further comprising modifying, based upon the user modification, a range of values of another offer parameter included in the one of the plurality of loan offers or the one or more updated loan offers.

7. The method of claim 1, further comprising closing, at the one or more computing devices, a loan corresponding to the selected one of the loan offers or the one or more updated loan offers, including at least one of:
receiving, at the one or more computing devices, an electronic signature of the applicant;
receiving, at the one or more computing devices, an electronic funds transfer corresponding to the accepted loan offer; or
electronically initiating, by the one or more computing devices, a disbursement of an amount of funds corresponding to the accepted loan offer.

8. The method of claim 1, wherein:
the one or more computing devices includes (i) a mobile device storing a client application, and (ii) a back-end computing device hosting a website or a server application;
a first portion of the method is performed by the client application executing on the mobile device; and
a second portion of the method is performed by the website or the server application hosted on the back-end computing device.

9. The method of claim 1, further comprising:
automatically updating, by the one or more computing devices, the plurality of loan offers, or the one or more updated loan offers, based on a change in interest rates to generate an updated plurality of loan offers; and
causing indications of the updated plurality of loan offers to be presented at the user interface.

10. The method of claim 9, further comprising receiving a user selection of one of the updated plurality of loan offers.

11. A system, comprising:
a loan application process provider comprising computer-executable instructions stored on one or more tangible, non-transitory memories, the loan application process provider communicatively connected to a plurality of user interface channels, and the plurality of user interface channels including (i) a local application executing on a mobile device accessible to a user; and (ii) a website or remote application hosted by a back-end computing device,
wherein the computer-executable instructions, when executed by one or more processors, cause the system to:
(a) receive loan application information corresponding to an application for a loan to purchase a vehicle, the loan application information including personal information corresponding to a loan applicant and vehicle information indicative of the vehicle, and the loan application information excluding an amount of the loan and excluding a term of the loan;
(b) provide, to the website or remote application via wired or wireless communication and/or data transmission, the received application information for underwriting;
(c) receive an indication of an underwriting approval of the application information;
(d) receive, at the mobile device, and via wired or wireless communication and/or data transmission, (i) a plurality of loan offers corresponding to the single loan application and determined based on the indication of the underwriting approval, each loan offer including respective offer information, and the respective offer information a plurality of offer parameters, the plurality of offer parameters including a loan amount, a loan term, an annual percentage rate (APR), and a periodic payment amount, and (ii) a range of values for an offer parameter of the plurality of offer parameters;
(e) cause one or more loan offers to be presented at a user interface of the mobile device, the one or more loan offers determined based on underwriting of the loan application information, and each loan offer including respective offer information;
(f) cause indications of (i) the range of values for the offer parameter and (ii) a current value of the offer parameter to be presented at the user interface;
(g) transmit, by the mobile device, and via wired or wireless communication and/or data transmission, an indication of a user modification of the current value within the range of values to the remote website or remote application;
(h) cause, by the mobile device, indications of one or more updated loan offers according to the user modification of the current value, to be presented at the user interface;
(i) receive a user selection of a particular loan offer from the one or more loan offers or the one or more updated loan offers; and
(j) close a loan corresponding to the particular loan offer,
and wherein the loan application process provider performs at least one of (a)-(j) by using a first user interface channel of the plurality of user interface channels, and the loan application process provider performs at least one other of (a)-(j) using a second user interface channel of the plurality of user interface channels.

12. The system of claim 11, wherein the plurality of user interface channels further includes a call center, an office of an agent of a provider of the loan, and a computing device used by the agent of the provider of the loan.

13. The system of claim 12, wherein the loan application process provider is configured to perform any one of (a)-(j) by using any one of the plurality of user interface channels.

14. The system of claim 11, wherein the loan application process provider closes the loan by using the local application executing on the mobile device or by using the website or remote application hosted by the back-end computing device.

15. The system of claim 14, wherein an electronic digital signature of the applicant is received via the local application executing on the mobile device or via the website or remote application hosted by the back-end computing device to close the loan.

16. The system of claim 11, wherein the respective offer information includes one or more offer parameters from a set of offer parameters including a loan amount, a loan term, an amount of a periodic loan payment, and an annual percentage rate (APR).

17. The system of claim 16, wherein:
the user selection of the particular loan offer includes a user modification to a value of a particular offer parameter included in the particular loan offer; and
the computer-executable instructions, when executed by the one or more processors, cause the system to further:
update a range of values of at least one other offer parameter included in the particular loan offer based on the user modification, and
cause the updated range of values of the at least one other offer parameter to be presented at the user interface.

18. The system of claim 11, wherein:
the computer-executable instructions, when executed by the one or more processors, cause the system further to electronically transfer funds corresponding to the close of the loan;
the electronic transfer of funds includes at least one of a disbursement of funds or a reception of funds; and
the electronic transfer of funds uses at least one of an automated clearing house, an electronically-generated check, an internal transfer, or certified funds.

19. The system of claim 11, wherein the one or more loan offers comprise one or more approved loan offers that are each modifiable within a set of approved ranges without having to further underwrite any of the approved loan offers.

20. A system, comprising:
one or more computing devices operated by a user, the one or more computing devices including one or more processors, one or more communication interfaces, a user interface, and one or more memory storage devices storing a particular set of computer-executable instructions, the particular set of computer-executable instructions particularly configuring the one or more computing devices to, when the particular set of computer-executable instructions are executed by the processor:
receive, at least in part via the user interface, application information for a single loan application to finance a vehicle, the application information including personal information corresponding to an applicant and vehicle information indicative of the vehicle, and the application information excluding an amount of the loan and excluding a term of the loan;
transmit, using the one or more communication interfaces, the received application information for underwriting;
receive, via the one or more communication interfaces, an indication of an underwriting approval of the application information;
receive, via the one or more communication interfaces, (i) a plurality of loan offers corresponding to the single loan application and determined based on the indication of the underwriting, each loan offer including respective offer information, and the respective offer information including a plurality of offer parameters, the plurality of offer parameters including a loan amount, a loan term, an annual percentage rate (APR), and a periodic payment amount, and (ii) a range of values for an offer parameter of the plurality of offer parameters;
present (i) indications of the ranges of respective values of the one or more offer parameters, and (ii) a current value of the respective one or more offer parameters to be presented at the user interface;
receiving, at least in part via the user interface, an indication of a user modification of one of the current values to be within the respective range of values of the one or more offer parameters;
present indications of one or more updated loan offers according to the modification of the one of the current values; and
receive, at the user interface in response to the presentation of the plurality of loan offers, an indication of a user selection of one of the plurality of loan offers or one or more updated loan offers.
